(19) United States
(12) Patent Application Publication
(10) Pub. No.: US 2021/0223642 A1
(43) Pub. Date: Jul. 22, 2021

(54) DISPLAY PANEL

(71) Applicant: Shenzhen China Star Optoelectronics Semiconductor Display Technology Co., Ltd., Shenzhen Guangdong (CN)

(72) Inventors: Qi ZHANG, Shenzhen (CN); Wu CAO, Shenzhen (CN)

(73) Assignee: Shenzhen China Star Optoelectronics Semiconductor Display Technology Co., Ltd., Shenzhen (CN)

(21) Appl. No.: 16/625,711

(22) PCT Filed: Dec. 9, 2019
(86) PCT No.: PCT/CN2019/123995

§ 371 Date: Dec. 22, 2019

(51) Int. Cl. G02F 1/1362; G02F 1/1368

(52) U.S. Cl. CPC G02F 1/136218; G02F 1/1368; G02F 1/136286

(57) ABSTRACT

The present invention provides a display panel. The display panel includes a substrate, a circuit layer, and a pixel layer. The circuit layer is arranged on the substrate and includes multiple data lines. The data lines are parallel to each other. The pixel layer is arranged on the circuit layer, and the pixel layer includes multiple shielding electrodes and multiple pixel electrodes. The shielding electrodes are arranged corresponding to the data lines, and each pixel electrode is placed between each two adjacent shielding electrodes. The shielding electrode includes multiple sub-shielding electrodes, and the sub-shielding electrodes are parallel to the data lines.

This application claims priority to Chinese patent application no. 201911179140.9, entitled “Display Panel”, filed on Nov. 27, 2019, the entire contents of which are incorporated by reference in this application.

### 1. FIELD OF DISCLOSURE

The present disclosure relates to a field of display technology and in particular, to a display panel.

### 2. DESCRIPTION OF RELATED ART

At present, in a manufacturing process of a display panel, in order to improve an aperture ratio of the panel, an indium tin oxide (ITO) material is provided above data lines. That is to say, the ITO material is disposed between adjacent pixel electrodes. When the display panel is in operation, liquid crystal molecules on the ITO material are not rotated to achieve a light shielding effect. The liquid crystal molecules are used to replace a black matrix (BM) originally arranged on a color filter substrate 104.

However, when images are displayed, the liquid crystal molecules are not rotated to ideal directions above a region of the ITO material between the adjacent pixel electrodes. As a result, dark strips appear in the region of the ITO material between the adjacent pixel electrodes, so that a light transmittance of the display panel is still low.

Therefore, it is necessary to provide a display panel which can improve the light transmittance.

### SUMMARY

The present invention provides a display panel to solve a lower light transmittance resulting from an existing dark strip formed between a shielding electrode and a pixel electrode in conventional display panels.

The present invention provides a display panel, comprising:

a substrate;

a circuit layer disposed on the substrate, wherein the circuit layer comprises a plurality of data lines, and the data lines are arranged parallel to each other; and

a pixel layer disposed on the circuit layer, the pixel layer comprising a plurality of shielding electrodes and a plurality of pixel electrodes, wherein the shielding electrodes are disposed corresponding to the data lines, each pixel electrode is disposed between each adjacent two of the shielding electrodes, the shielding electrode comprises a plurality of sub-shielding electrodes, and the sub-shielding electrodes are arranged parallel to the data lines.

According to one embodiment of the present invention, the pixel electrode comprises a boundary electrode, the boundary electrode is disposed on one side of the pixel electrode adjacent to the shielding electrode, the boundary electrode has a strip shape, and the boundary electrode is arranged parallel to the corresponding sub-shielding electrodes.

According to one embodiment of the present invention, a width of the boundary electrode is equal to or greater than 2 micrometers, and the width of the boundary electrode is equal to or less than 6 micrometers.

According to one embodiment of the present invention, a distance between the shielding electrode and the pixel electrode is equal to or greater than 2 micrometers.

According to one embodiment of the present invention, a distance between each adjacent two of the sub-shielding electrodes is equal to or greater than 2 micrometers.

According to one embodiment of the present invention, a width of the shielding electrode is greater than a width of the corresponding data line.

The present invention provides a display panel, comprising:

a substrate;

a circuit layer disposed on the substrate, wherein the circuit layer comprises a plurality of data lines, and the data lines are arranged parallel to each other; and

a pixel layer disposed on the circuit layer, the pixel layer comprising a plurality of shielding electrodes and a plurality of pixel electrodes, wherein the shielding electrodes are disposed corresponding to the data lines, each pixel electrode is disposed between each adjacent two of the shielding electrodes, the shielding electrode comprises a plurality of sub-shielding electrodes, the sub-shielding electrodes are arranged parallel to the data lines, the pixel electrode comprises a boundary electrode, the boundary electrode is disposed on one side of the pixel electrode adjacent to the shielding electrode, the boundary electrode has a strip shape, the boundary electrode is arranged parallel to the sub-shielding electrode, and a width of the shielding electrode is greater than a width of the corresponding data line.

According to one embodiment of the present invention, a width of the boundary electrode is equal to or greater than 2 micrometers, and the width of the boundary electrode is equal to or less than 6 micrometers.

According to one embodiment of the present invention, a distance between the shielding electrode and the pixel electrode is equal to or greater than 2 micrometers.

According to one embodiment of the present invention, a distance between each adjacent two of the sub-shielding electrodes is equal to or greater than 2 micrometers.

The present invention further provides a display panel, comprises:

a substrate;

a circuit layer disposed on the substrate, wherein the circuit layer comprises a plurality of data lines, and the data lines are arranged parallel to each other;

a pixel layer disposed on the circuit layer, the pixel layer comprising a plurality of shielding electrodes and a plurality of pixel electrodes, wherein the shielding electrodes are disposed corresponding to the data lines, and each pixel electrode is disposed between each adjacent two of the shielding electrodes; and

a voltage generator electrically connected to the shielding electrodes and the pixel electrodes, wherein the voltage generator is configured to apply a same voltage to the shielding electrodes and the pixel electrodes while an alignment process of the display panel is performed.

According to one embodiment of the present invention, the shielding electrode comprises a plurality of sub-shielding electrodes, and the sub-shielding electrodes are arranged parallel to the data lines.

According to one embodiment of the present invention, the pixel electrode comprises a boundary electrode, the boundary electrode is disposed on one side of the pixel electrode adjacent to the shielding electrode, the boundary electrode has a strip shape, and the boundary electrode is arranged parallel to the sub-shielding electrode.

According to one embodiment of the present invention, a width of the boundary electrode is equal to or greater than 2 micrometers, and the width of the boundary electrode is equal to or less than 6 micrometers.

### Advantages of the Present Invention

The present invention provides a display panel. The display panel comprises a substrate, a circuit layer, and a pixel layer. The circuit layer comprises a plurality of data lines. The pixel layer comprises a plurality of shielding electrodes and a plurality of pixel electrodes. The shielding electrodes are disposed corresponding to the data lines. The shielding electrode comprises a plurality of sub-shielding electrodes. The sub-shielding electrodes are parallel to the data lines. This way, a dark strip between the shielding electrode and the pixel electrode is reduced, and thereby a light transmittance of the display panel is improved.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without an inventive work.

FIG. 1 is a schematic cross-sectional view illustrating a display panel according to one embodiment of the present invention;

FIG. 2 is a schematic cross-sectional view illustrating the display panel according to another embodiment of the present invention;

FIG. 3 is a schematic top view illustrating a pixel layer according to one embodiment of the present invention;

FIG. 4 is a schematic view illustrating rotation of liquid crystal molecules according to one embodiment of the present invention;

FIG. 5 is a graph illustrating light transmittances of the display panel according to one embodiment of the present invention;

FIG. 6 is a cross-sectional view illustrating the display panel according to still another embodiment of the present invention; and

FIG. 7 is a schematic cross-sectional view illustrating the display panel according to yet still another embodiment of the present invention.

### DETAILED DESCRIPTION OF EMBODIMENTS

Technical solutions of the present invention will be clearly and completely described below with reference to specific embodiments and the accompanying drawings. It is apparent that the embodiments are only some embodiments of the present invention, and not all of the embodiments. All other embodiments obtained by those skilled in the art based on the embodiments of the present invention without an inventive step are deemed to be within the protection scope of the present invention.

In the description of the present invention, it should be understood that the directional terms such as “on”, “under”, “near”, or the likes are based on orientations or positional relationship shown in the drawings, wherein “on” refers to being right or obliquely over or on an upper surface of an object, as long as it is above a level of the object. “Adjacent” refers to two objects having a region between them and near each other. The above directional or positional relationships are merely for ease of description of the present invention, and do not indicate or imply that the device or element referred to must have a specific orientation, or be constructed or operated in a specific orientation, and therefore cannot be understood as limitations on the present invention.

It should be noted that the terms “horizontal” and “vertical” are in relation to a display plane on a horizontal plane. The “vertical” direction points to a center of the earth, and a “vertical” surface is perpendicular to a “horizontal” surface. In addition, the drawings only show structures or steps that are more closely related to the present invention, and omit some details that are not very relevant to the present invention. The purpose is to simplify and clarify the drawings, but it does not mean that an actual device or method is exactly a same as the accompanying drawing, so the drawings are not intended to limit the device or method.

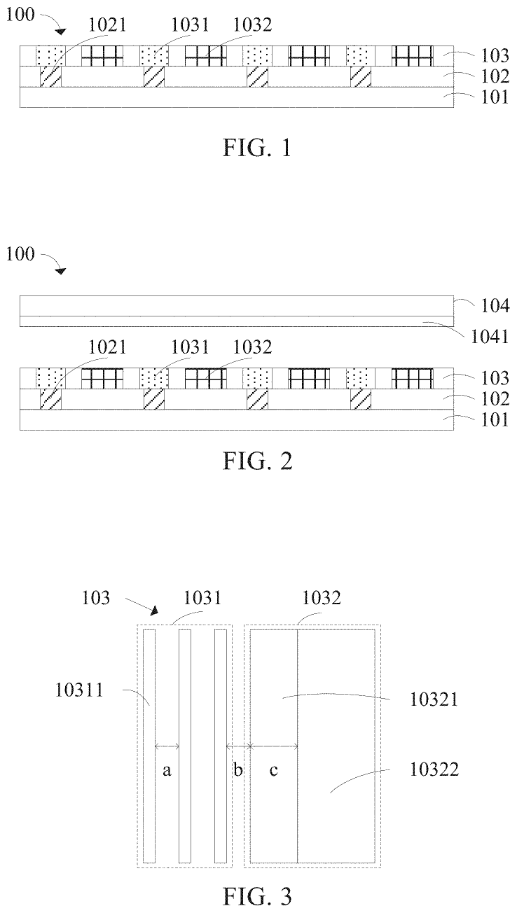

The present invention provides a display panel. The display panel comprises, but is not limited to, embodiments shown in FIGS. 1 to 5.

According to one embodiment, as shown in FIG. 1, the display panel 100 comprises a substrate 101, a circuit layer 102 disposed on the substrate 101, and a pixel layer 103 disposed on the circuit layer 102. The circuit layer 102 comprises a plurality of data lines 1021, and the data lines 1021 are parallel to each other. The pixel layer 103 comprises a plurality of shielding electrodes 1031 and a plurality of pixel electrodes 1032, wherein the shielding electrodes 1031 are disposed corresponding to the data lines 1021. Each pixel electrode 1032 is disposed between each adjacent two of the shielding electrodes 1031.

The substrate 101 may be a glass substrate. Material of the glass substrate can include at least one of quartz powder, strontium carbonate, barium carbonate, boric acid, boric anhydride, aluminum oxide, calcium carbonate, barium nitrate, magnesium oxide, tin oxide, and zinc oxide.

The circuit layer 102 comprises a plurality of gate lines, a plurality of thin film transistor devices, and other metal circuits. The gate lines are parallel to each other, and the gate lines and the data lines 1021 are intersected to form a plurality of rectangular regions. The thin film transistor devices are disposed in the rectangular regions, and a source or a drain of the thin film transistor device is electrically connected to the pixel electrode 1032. The gate line is configured to transmit a row signal to the thin film transistor devices to control the thin film transistor devices of a certain row to be switched on. The data line 1021 is configured to transmit a column signal to the thin film transistor devices to control the corresponding pixel electrodes 1032 to display images.

The shielding electrode 1031 and the pixel electrode 1032 may be made of an electrically conductive transparent material. In detail, the shielding electrode 1031 and the pixel electrode 1032 can be made of an indium tin oxide (ITO) material.

According to one embodiment, as shown in FIG. 2, the display panel 100 further comprises a color filter substrate 104. The color filter substrate 104 is disposed on one side of the pixel layer 103 away from the substrate 101, and the color filter substrate 104 is disposed corresponding to the substrate 101. A plurality of liquid crystal molecules are arranged between the pixel layer 103 and the color filter substrate 104. Light can pass through by rotation of the liquid crystal molecules.

In detail, the color filter substrate 104 comprises a common electrode 1041. The common electrode 1041 is disposed one side of the color filter substrate 104 adjacent to the pixel layer 103. The common electrode 1041 can be a transparent conductive material as an entire planar structure, and the transparent conductive material is, for example, ITO.

When an alignment process of the display panel 100 is performed, different voltages are applied to the pixel layer 103 and the common electrode 1041. A vertical electric field is formed between the pixel layer 103 and the common electrode 1041, the liquid crystal molecules between the pixel layer 103 and the common electrode 1041 are rotated to form a predetermined tilted angle. Moreover, after the pixel layer 103 is patterned to form multiple electrodes, similarly, an electric field is formed between each electrode and the common electrode 1041. That is to say, a plane of the electric field is in a vertical direction. Projections of the planes of the electric fields projected on the pixel layer 103 coincide with the electrodes, and the liquid crystal molecules are rotated by the electric fields.

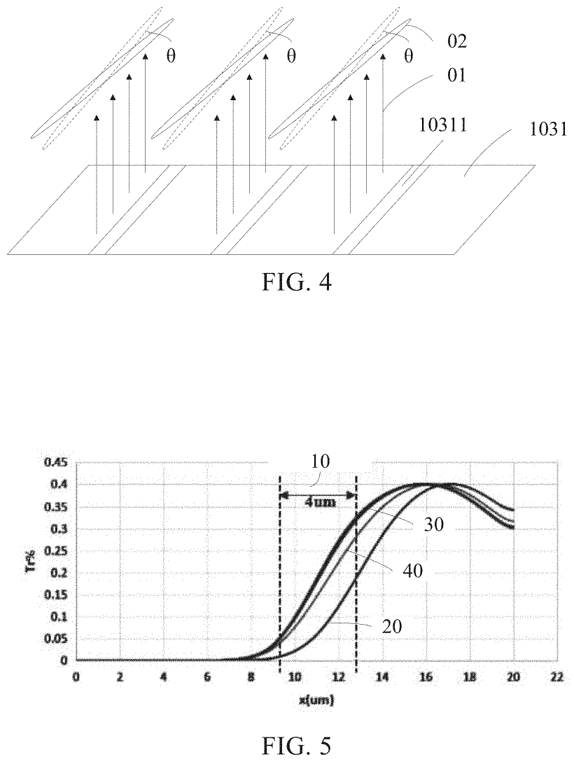

Particularly, as shown in FIG. 3, the shielding electrode 1031 comprises a plurality of sub-shielding electrodes 10311, and the sub-shielding electrodes 10311 are parallel to the data lines 1021. Referring to FIG. 4, since the sub-shielding electrodes 10311 and the data lines 1021 are parallel to each other, multiple mutually parallel electric fields 01 are formed between the sub-shielding electrodes 10311 and the common electrode 1041. Thus, liquid crystal molecules 02 arranged above each of the sub-shielding electrodes 10311 are rotated by the electric field 01 to form a predetermined tilted angle θ.

For each liquid crystal molecule 02 above one shielding electrode 1031, the liquid crystal molecule 02 receives not only a force from the corresponding electric field 01 and but also an interaction force from adjacent liquid crystal molecules 02, so that each liquid crystal molecule 02 is more easily to rotate. Therefore, liquid crystal molecules 02 above a region between the shielding electrode 1031 and the pixel electrode 1032 are also easier to rotate. Therefore, when there are more sub-shielding electrodes 10311, it is easier to make the liquid crystal molecules 02 rotate.

As shown in Table 1, Table 1 shows light transmittances at A, B, and C when the liquid crystal molecules above B are at different horizontal rotation angles, the liquid crystal molecules above A, B, and, C are at different vertical rotation angles. The horizontal rotation angle represents an angle between the liquid crystal molecule and a horizontal-right vector in a horizontal direction. A horizontal rotation angle of 0° represents that the liquid crystal molecule are oriented toward a horizontal-right direction. A vertical rotation angle represents an angle between the liquid crystal molecule and a horizontal plane in a vertical direction. The vertical rotation angle is θ shown in FIG. 4; A, B, and, C respectively represent the liquid crystal molecules above the shielding electrode 1031, the liquid crystal molecules above the region between the shielding electrode 1031 and the pixel electrode 1032, and the liquid crystal molecules above the pixel electrode 1032. It can be known from Table 1 that, when the vertical rotation angles of the liquid crystal molecules above A, B, and, C are constant, and the vertical rotation angle of the liquid crystal molecules above B is 90°, the corresponding light transmittances at A, B, and C are the largest.

TABLE 1

| Horizontal | Vertical Rotation Angle (A/B/C) | | |
|---|---|---|---|
| Rotation Angle (B) | 0.7° | 0.9° | 1.2° |
| 0° | 9.09% | 9.51% | 10.02% |
| 70° | 9.52% | 10.03% | 10.67% |
| 90° | 9.56% | 10.09% | 10.74% |
| 110° | 9.55% | 10.08% | 10.73% |

Referring to FIG. 5, it is a graph illustrating light transmittances corresponding to different positions in the pixel layer 103. The abscissa “x” represents a distance from a border of the display panel 100, and the border is located on one side adjacent to the shielding electrode 1031. The ordinate “Tr %” represents light transmittances. In detail, “10” represents the region between the shielding electrode 1031 and the pixel electrode 1032, and “20” represents a curve of corresponding light transmittances when the horizontal rotation angle of the liquid crystal molecules above the “10” is 0°. “30” and “40” indicate curves of corresponding light transmittances when the horizontal rotation angle above the “10” is close to 90°. It can be known from FIG. 5 that, when the horizontal rotation angle of the liquid crystal molecules above the region between the shielding electrode 1031 and the pixel electrode 1032 is near 90°, the corresponding light transmittances are larger.

In summary, it can be known that when the sub-shielding electrodes 10311 are arranged parallel to the data lines 1021, the more the sub-shielding electrodes 10311 are, the more easily the liquid crystal molecules 02 rotate. The above-mentioned rotation directions comprise the liquid crystal molecules 02 being rotated toward the data lines 1021 in the horizontal direction, and the data line 1021 can also be arranged in a direction that the horizontal rotation angle is 90°. Therefore, the light transmittance in the region between the shielding electrode 1031 and the pixel electrode 1032 can be increased by providing the shielding electrode 1031 with multiple sub-shielding electrodes 10311 parallel to the data lines 1021.

Referring to FIG. 3, according to one embodiment of the present invention, the pixel electrode 1032 comprises a boundary electrode 10321, the boundary electrode 10321 is disposed on one side of the pixel electrode 1032 adjacent to the shielding electrode 1031. The boundary electrode 10321 has a strip shape, and the boundary electrode 10321 is arranged parallel to the sub-shielding electrode 10311. A distance a between each adjacent two of the sub-shielding electrodes 10311 is equal to or greater than 2 micrometers. A distance b between the shielding electrode 1031 and the pixel electrode 1032 is equal to or greater than 2 micrometers. A width c of the boundary electrode 10321 is equal to or greater than 2 micrometers, and the width c of the boundary electrode 10321 is equal to or less than 6 micrometers. Moreover, the width c of the boundary electrode 10321 can also be 2 micrometers.

When the boundary electrode 10321 has a strip shape, and the boundary electrode 10321 is parallel to the sub-shielding electrode 10311, the liquid crystal molecules arranged above the boundary electrode 10321 and the sub-shielding electrode 10311 can be rotated in a vertical direction on condition that the horizontal rotation angle is 90°. Similarly, due to the presence of the boundary electrode 10321 and because of the interaction force between the liquid crystal molecules, the liquid crystal molecules arranged above the region between the pixel electrode 1032 and the shielding electrode 1031 are also easier to rotate to the horizontal rotation angle of 90° under the influence of the liquid crystal molecules at two sides.

The pixel electrode 1032 further comprises an internal electrode 10322, the internal electrode 10322 can comprise a plurality of branch electrodes. The branch electrodes can be arranged parallel to each other along a predetermined direction. The predetermined direction is different from a direction of the boundary electrode 10321, and the predetermined direction is not perpendicular to the direction of the boundary electrode 10321. Similarly, due to the interaction force between the liquid crystal molecules, the liquid crystal molecules above the branch electrodes can be rotated in the horizontal direction toward the predetermined direction to increase the light transmittance there.

According to one embodiment of the present invention, a width of the shielding electrode 1031 is greater than a width of the corresponding data line 1021. The shielding electrode 1031 can completely shield the corresponding data line 1021 to prevent light leakage in a dark state and improve contrast ratios.

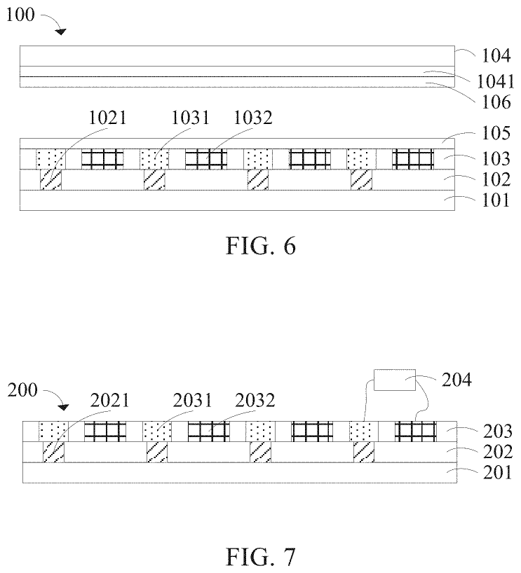

Referring to FIG. 6, according to one embodiment of the present invention, the display panel 100 further comprises a first alignment layer 105 and a second alignment layer 106. The first alignment layer 105 is disposed on the pixel layer 103, and the second alignment layer 106 is disposed one side of the pixel layer 103 adjacent to the common electrode 1041. The first alignment layer 105 comprises a plurality of first alignment portions, and the first alignment portions are disposed corresponding to the shielding electrodes 1031 and the pixel electrodes 1032. The second alignment layer 106 comprises a plurality of second alignment portions, and the second alignment portions can be parallel to or perpendicular to the first alignment portions. Furthermore, the liquid crystal molecules can further include alignment particles.

Material of the first alignment layer 105 and the second alignment layer 106 can include polyimide. The alignment particles may be reactive monomers. Under the above alignment conditions, the alignment particles can drive the liquid crystal molecules to rotate under an action of the first alignment layer 105 and the second alignment layer 106, so that the liquid crystal molecules are more easily rotated, and the rotation efficiency of the liquid crystal molecules is improved.

The present invention further provides a display panel, the display panel comprises, but is not limited to, an embodiment shown in FIG. 7.

Referring to FIG. 7, according to one embodiment, the display panel 200 comprises a substrate 201, a circuit layer 202 disposed on the substrate 201, a pixel layer 203 disposed on the circuit layer 202, and a voltage generator 204. The circuit layer 202 comprises a plurality of data lines 2021, and the data lines 2021 are parallel to each other. The pixel layer 203 comprises a plurality of shielding electrodes 2031 and a plurality of pixel electrodes 2032. The shielding electrodes 2031 are disposed corresponding to the data lines 2021, and each pixel electrode 2032 is disposed between each adjacent two of the shielding electrodes 2031. The voltage generator 204 is electrically connected to the shielding electrodes 2031 and the pixel electrodes 2032.

For the substrate 201, the circuit layer 202, the shielding electrode 2031, and the pixel electrode 2032, please refer to the related descriptions about the substrate 101, the circuit layer 102, the shielding electrode 1031, and the pixel electrode 1032.

In one embodiment, the display panel 200 further comprises a color filter substrate. The color filter substrate can include a common electrode. For the color filter substrate and the common electrode, please refer to the related description about the color filter substrate 104 and the common electrode 1041.

Specifically, the voltage generator 204 is configured to apply a same voltage to the shielding electrodes 2031 and the pixel electrodes 2032 while an alignment process of the display panel 200 is performed. It should be noted that when the voltage on the common electrode is constant, there is no voltage difference between the shielding electrode 2031 and the pixel electrode 2032 in a horizontal direction if the shielding electrode 2031 and the pixel electrode 2032 have the same voltage. That is to say, there is no electric field generated between the shielding electrode 2031 and the pixel electrode 2032. Rotation directions of the liquid crystal molecules above a region between the shielding electrode 2031 and the pixel electrode 2032 in the horizontal direction are only affected by the adjacent liquid crystal molecules.

Furthermore, the pixel electrode 2032 comprises a boundary electrode, the boundary electrode is disposed on one side of the pixel electrode 2032 adjacent to the shielding electrode 2031. The boundary electrode has a strip shape, and the boundary electrode is parallel to the shielding electrode 2031. In summary, the rotation direction of the liquid crystal molecules in the horizontal direction above the region between the shielding electrode 2031 and the pixel electrode 2032 is consistent with the configuration of the shielding electrode 2031 and the boundary electrode, thus reducing the influence of the electric field between the shielding electrode 2031 and the pixel electrode 2032 on the liquid crystal molecules above the region between the shielding electrode 2031 and the pixel electrode 2032, thereby improving the light transmittance.

According to one embodiment, the shielding electrode comprises a plurality of sub-shielding electrodes, and the sub-shielding electrodes are arranged in parallel with the data lines.

For specific arrangement/configuration of the boundary electrode and the sub-shielding electrodes, please refer to the related descriptions above.

The present invention provides a display panel. The display panel comprises a substrate, a circuit layer, and a pixel layer. The circuit layer comprises a plurality of data lines parallel to each other. The pixel layer comprises a plurality of shielding electrodes and a plurality of pixel electrodes. The shielding electrodes are disposed corresponding to the data lines. The shielding electrode comprises a plurality of sub-shielding electrodes, and the sub-shielding electrodes are arranged in parallel with the data lines. This way, a dark strip between the shielding electrode and the pixel electrode is reduced, and a light transmittance of the display panel is improved.

Please be noted that equivalent replacements or changes can be made by persons of ordinary skills in the art based on the technical solution of the present invention and its concepts, and all such changes or replacements should be deemed to be within the protection scope of the appended claims of the present invention.

What is claimed is:

1. A display panel, comprising:
a substrate;
a circuit layer disposed on the substrate, wherein the circuit layer comprises a plurality of data lines, and the data lines are arranged parallel to each other; and
a pixel layer disposed on the circuit layer, the pixel layer comprising a plurality of shielding electrodes and a plurality of pixel electrodes, wherein the shielding electrodes are disposed corresponding to the data lines, each pixel electrode is disposed between each adjacent two of the shielding electrodes, the shielding electrode comprises a plurality of sub-shielding electrodes, and the sub-shielding electrodes are arranged parallel to the data lines.

2. The display panel according to claim 1, wherein the pixel electrode comprises a boundary electrode, the boundary electrode is disposed on one side of the pixel electrode adjacent to the shielding electrode, the boundary electrode has a strip shape, and the boundary electrode is arranged parallel to the corresponding sub-shielding electrodes.

3. The display panel according to claim 2, wherein a width of the boundary electrode is equal to or greater than 2 micrometers, and the width of the boundary electrode is equal to or less than 6 micrometers.

4. The display panel according to claim 1, wherein a distance between the shielding electrode and the pixel electrode is equal to or greater than 2 micrometers.

5. The display panel according to claim 1, wherein a distance between each adjacent two of the sub-shielding electrodes is equal to or greater than 2 micrometers.

6. The display panel according to claim 1, wherein a width of the shielding electrode is greater than a width of the corresponding data line.

7. A display panel, comprising:
a substrate;
a circuit layer disposed on the substrate, wherein the circuit layer comprises a plurality of data lines, and the data lines are arranged parallel to each other; and
a pixel layer disposed on the circuit layer, the pixel layer comprising a plurality of shielding electrodes and a plurality of pixel electrodes, wherein the shielding electrodes are disposed corresponding to the data lines, each pixel electrode is disposed between each adjacent two of the shielding electrodes, the shielding electrode comprises a plurality of sub-shielding electrodes, the sub-shielding electrodes are arranged parallel to the data lines, the pixel electrode comprises a boundary electrode, the boundary electrode is disposed on one side of the pixel electrode adjacent to the shielding electrode, the boundary electrode has a strip shape, the boundary electrode is arranged parallel to the sub-shielding electrode, and a width of the shielding electrode is greater than a width of the corresponding data line.

8. The display panel according to claim 7, wherein a width of the boundary electrode is equal to or greater than 2 micrometers, and the width of the boundary electrode is equal to or less than 6 micrometers.

9. The display panel according to claim 7, wherein a distance between the shielding electrode and the pixel electrode is equal to or greater than 2 micrometers.

10. The display panel according to claim 7, wherein a distance between each adjacent two of the sub-shielding electrodes is equal to or greater than 2 micrometers.

11. A display panel, comprising:
a substrate;
a circuit layer disposed on the substrate, wherein the circuit layer comprises a plurality of data lines, and the data lines are arranged parallel to each other;
a pixel layer disposed on the circuit layer, the pixel layer comprising a plurality of shielding electrodes and a plurality of pixel electrodes, wherein the shielding electrodes are disposed corresponding to the data lines, and each pixel electrode is disposed between each adjacent two of the shielding electrodes; and
a voltage generator electrically connected to the shielding electrodes and the pixel electrodes, wherein the voltage generator is configured to apply a same voltage to the shielding electrodes and the pixel electrodes while an alignment process of the display panel is performed.

12. The display panel according to claim 11, wherein the shielding electrode comprises a plurality of sub-shielding electrodes, and the sub-shielding electrodes are arranged parallel to the data lines.

13. The display panel according to claim 11, wherein the pixel electrode comprises a boundary electrode, the boundary electrode is disposed on one side of the pixel electrode adjacent to the shielding electrode, the boundary electrode has a strip shape, and the boundary electrode is arranged parallel to the sub-shielding electrode.

14. The display panel according to claim 13, wherein a width of the boundary electrode is equal to or greater than 2 micrometers, and the width of the boundary electrode is equal to or less than 6 micrometers.
